(19) United States
(12) Patent Application Publication
(10) Pub. No.: US 2014/0238793 A1
(43) Pub. Date: Aug. 28, 2014

(54) ELECTROMAGNETIC SUSPENSION APPARATUS

(71) Applicant: Hitachi Automotive Systems, Ltd., Ibaraki (JP)

(72) Inventors: Shogo NANBARA, Hitachinaka-shi (JP); Fumiyuki YAMAOKA, Sagamihara-shi (JP); Noriyuki UTSUMI, Tokyo (JP); Tomoyuki LEE, Kawasaki-shi (JP)

(73) Assignee: Hitachi Automotive Systems, Ltd., Ibaraki (JP)

(21) Appl. No.: 14/190,658

(22) Filed: Feb. 26, 2014

(30) Foreign Application Priority Data
Feb. 28, 2013 (JP) 038982/2013

(51) Int. Cl. F16F 6/00

(52) U.S. Cl. CPC F16F 6/00
USPC 188/267

(57) ABSTRACT

An electromagnetic suspension apparatus includes a stator disposed on a vehicle body side and including a core and coils, a movable element disposed on a wheel side and including an outer rube and permanent magnets, and a cylinder apparatus located inside the stator and the movable element and disposed between the vehicle body side and the wheel side. A rod of the cylinder apparatus and the outer tube are nonrigidly coupled to each other via a coupling member formed as an elastically deformable elastic body. When a lateral force is applied, the coupling member is elastically deformed, by which the outer tube moves or swings relative to the rod so that the coils and the permanent magnets can be prevented from contacting each other.

### BACKGROUND OF THE INVENTION

The present invention relates to an electromagnetic suspension apparatus that is preferably used to absorb a vibration of a vehicle such as an automobile.

Generally, a vehicle such as an automobile is provided with a shock absorber disposed between a vehicle body (sprung) side and each wheel (unsprung) side. As such a shock absorber, there is known an electromagnetic suspension apparatus using a linear motor (an electromagnetic actuator) that includes a stator and a movable element disposed so as to be relatively linearly movable relative to each other.

The electromagnetic suspension apparatus includes, for example, a tubular linear electromagnetic actuator. The electromagnetic actuator is disposed between a vehicle body and a wheel, and includes a coil (a coil member) and a magnet (a magnetic member). The coil is disposed at an outer tube, which is one of relatively displaceable coaxial inner and outer tubes. The magnet is disposed at the inner tube, which is the other member thereof and is disposed so as to face the coil (for example, refer to Japanese Patent Application Public Disclosure Nos. 2012-131303 and 2004-278783).

The electromagnetic suspension apparatus mounted on the vehicle such as an automobile may receive a force applied in a direction (a lateral direction) perpendicular to a direction of the relative displacement (a stoke direction), i.e., a lateral force that is a force applied in a direction causing misalignment between an axial central line of the outer tube and an axial central line of the inner tube. In this case, if contact is made between the coil and the magnet that face each other with an interval (a space) radially generated therebetween, this may result in deterioration of the durability of these coil and magnet.

A possible method to prevent this situation is, for example, to increase the radial interval between the coil and the magnet. However, in this case, only a smaller force is generated between the coil and the magnet, leading to a possibility of deterioration of the performance of the electromagnetic suspension apparatus, such as a reduction in a thrust force of the electromagnetic actuator and an increase in power consumption.

### SUMMARY OF THE INVENTION

The present invention has been conceived in consideration of the above-described drawback of the conventional technique, and an object of the present invention is to provide an electromagnetic suspension apparatus capable of improving a performance and durability.

To achieve the above-described object, the present invention provides an electromagnetic suspension apparatus configured to be disposed between a vehicle body and a wheel, and including a tubular linear electromagnetic actuator. The tubular linear electromagnetic actuator includes a coil member disposed at one of a relatively displaceable coaxial inner tube and outer tube, and a magnetic member disposed at the other of the inner tube and the outer tube and arranged so as to face the coil member. The electromagnetic suspension apparatus further includes a cylinder having one end side disposed in the inner tube and an opposite end side configured to be attached to a vehicle body side member, a rod having one end side inserted in the cylinder and an opposite end side configured to be attached to a wheel side member, a rod guide slidably supporting the rod on the one end side of the cylinder, a seal member disposed on a wheel side of the rod guide and providing a seal to gas and liquid mixed in the cylinder, and a guide member disposed on the one end side of the rod and configured to slide in the cylinder. One of the inner tube and the outer tube is coupled to the cylinder, and the other of the inner tube and the outer tube is coupled to the rod. The electric magnetic suspension apparatus has one of a first state and a second state. In the first state, a coupling portion 24 between the cylinder and the one of the inner tube and the outer tube is nonrigidly, movably, or swingably (rockingly or shakingly) coupled. In the second state, a coupling portion 23 between the rod and the other of the inner tube and the outer tube is nonrigidly, movably, or swingably (rockingly or shakingly) coupled.

### BRIEF DESCRIPTION OF THE DRAWINGS

FIG. 1 is a vertical cross-sectional view illustrating an electromagnetic suspension apparatus according to a first embodiment in a compressed state.

FIG. 2 is a vertical cross-sectional view illustrating the electromagnetic suspension apparatus taken along a direction indicated by arrows II-II in FIG. 1.

FIG. 3 is a transverse cross-sectional view illustrating the electromagnetic suspension apparatus taken along a direction indicated by arrows III-III in FIG. 1.

FIG. 4 is a transverse cross-sectional view illustrating an attachment rod and the like of the electromagnetic suspension apparatus taken along a direction indicated by arrows IV-IV in FIG. 1.

FIG. 5 is a vertical cross-sectional view illustrating the electromagnetic suspension apparatus in an extended state taken along the same direction as FIG. 1.

FIG. 6 is a vertical cross-sectional view illustrating an electromagnetic suspension apparatus according to a second embodiment in a compressed state.

FIG. 7 is a vertical cross-sectional view illustrating an electromagnetic suspension apparatus according to a third embodiment in a compressed state.

FIG. 8 is a vertical cross-sectional view illustrating an electromagnetic suspension apparatus according to a fourth embodiment in a compressed state.

FIG. 9 is a cross-sectional view especially illustrating main parts such as an outer tube, a magnetic member, and a magnetic body according to a fifth embodiment.

FIG. 10 is a transverse cross-sectional view illustrating an attachment rod and the like of an electromagnetic suspension apparatus according to a first modification taken along the same direction as FIG. 4.

FIG. 11 is a transverse cross-sectional view illustrating an attachment rod and the like of an electromagnetic suspension apparatus according to a second modification taken along the same direction as FIG. 4.

### DETAILED DESCRIPTION OF THE PREFERRED EMBODIMENTS

In the following description, electromagnetic suspension apparatuses according to embodiments of the present invention will be described in detail with reference to the accompanying drawings.

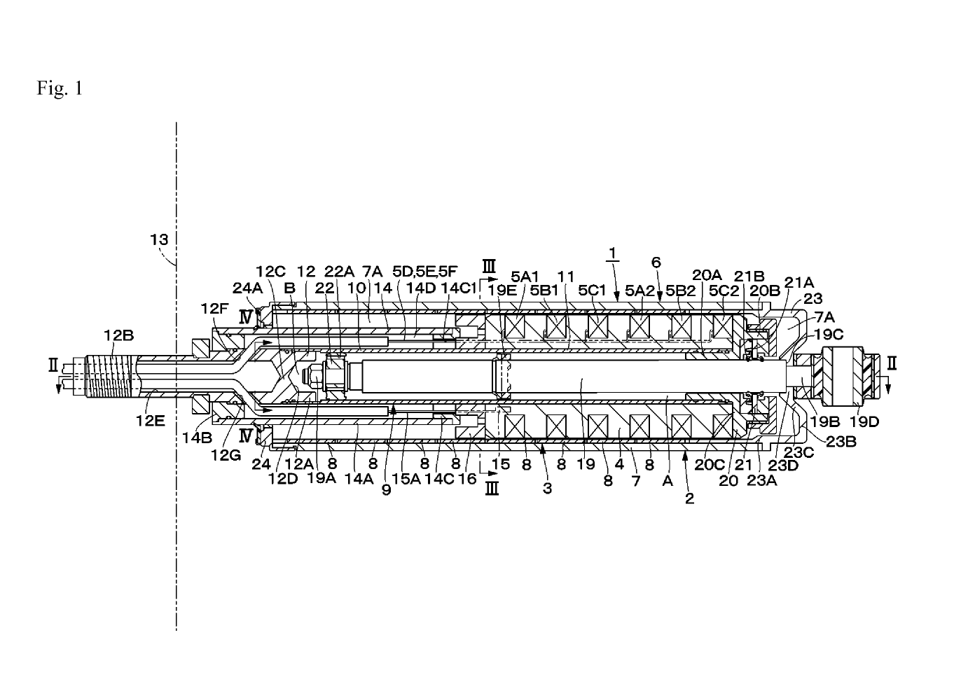

FIGS. 1 to 5 illustrate a first embodiment of the present invention. Referring to these figures, an electromagnetic suspension apparatus 1 is configured as an electromagnetic suspension (an electric suspension) using a linear motor (a linear actuator). More specifically, the electromagnetic suspension apparatus 1 includes a stator 2 disposed on a not-illustrated vehicle body side, a movable element 6 disposed on a not-illustrated wheel side, a cylinder apparatus 9 located inside (on a radially inner side of) the stator 2 and the movable element 6 and disposed between the vehicle body side and the wheel side, and a not-illustrated spring (a suspension spring or a coil spring) located outside (on a radially outer side of) the stator 2 and the movable element 6 and disposed between the vehicle body side and the wheel side. Then, a three-phase linear synchronous motor is constituted by the stator 2 (an armature) and the movable element 6 (a field system).

In other words, the electromagnetic suspension apparatus 1 includes a tubular linear electromagnetic actuator 3 disposed between a vehicle body (a sprung side) and a wheel (an unsprung side). The tubular linear electromagnetic actuator 3 includes coils 5A1, 5B1, 5C1, 5A2, 5B2, and 5C2 (a coil member) disposed at a core 4 corresponding to an inner tube, which is one of relatively displaceable coaxial inner and outer tubes, and permanent magnets 8 (a magnetic member) disposed at an outer tube 7 corresponding to the outer tube and arranged so as to face the coils 5A1, 5B1, 5C1, 5A2, 5B2, and 5C2.

Although not illustrated, the tubular linear electromagnetic actuator may be also configured in such a manner that the coils (the coil member) are disposed at the outer tube, and the permanent magnets (the magnetic member) are disposed at the inner tube, in which the inner tube is disposed on the radially inner side and the outer tube is disposed on the radially outer side.

The stator 2 disposed on the vehicle body side is configured as an armature. The stator (the armature) 2 includes the core 4 as the inner tube, and the plurality of coils 5A1, 5B1, 5C1, 5A2, 5B2, and 5C2 as the coil member disposed at the core 4. The core 4 is made of, for example, a power magnetic core, stacked electromagnetic steel sheets, or a magnetic body piece, and is formed by cutting processing or the like. The shape thereof is substantially cylindrical as a whole. The core 4 is coupled to a cylinder 10 of the cylinder apparatus 9, which will be described below. On the other hand, the respective coils 5A1, 5B1, 5C1, 5A2, 5B2, and 5C2 are respectively wound in a predetermined direction and are contained on an outer circumferential surface side of the core 4, and are arranged so as to face an inner circumferential surface of the movable element 6 (the permanent magnets 8 thereof), which will be described below.

More specifically, the coils 5A1, 5B1, 5C1, 5A2, 5B2, and 5C2 are located on the outer circumferential surface side of the substantially tubular core 4, and are arranged in a circumferential direction of the core 4. The coils 5A1, 5B1, 5C1, 5A2, 5B2, and 5C2 are disposed so as to be axially spaced apart at six positions in an axial direction of the core 4. The coils 5A1 and 5A2 are connected to a not-illustrated controller (a control device) and a power source via a power line 5D. The coils 5B1 and 5B2 are connected to the controller and the power source via a power line 5E. The coils 5C1 and 5C2 are connected to the controller and the power source via a power line 5F. Power is supplied to these coils via the power lines 5D, 5E, and 5F.

The number of the coils 5A1, 5B1, 5C1, 5A2, 5B2, and 5C2 are not limited to the illustrated example, and may be arbitrarily set according to a design specification and the like. Further, axially adjacent coils among the six coils, like the coils 5A1, 5B1, and 5C1, and the coils 5A2, 5B2, and 5C2 are disposed so as to have, for example, a phase difference of 120 degrees for each pair with respect to the electrical angle. Therefore, in this case, the coil 5A1 and the coil 5A2 are arranged in a same phase (for example, the U phase) with respect to the electrical angle. Similarly, the coil 5B1 and the coil 5B2 are arranged in a same phase (for example, the V phase) with respect to the electrical angle. Further, the coil 5C1 and the coil 5C2 are also arranged in a same phase (for example, the W phase) with respect to the electrical angle. Obviously, the wiring method may be arbitrarily selected according to a voltage of a driving power source side and a specification of an electric current.

The movable element 6 disposed on the wheel side constitutes a field system, and is mounted on the stator 2 so as to be relatively displaceable in an axial direction, which corresponds to a stroke direction. The movable element 6 includes the outer tube 7 as the outer tube disposed on the outer circumferential side of the armature (the core 4 and the coils 5A1, 5B1, 5C1, 5A2, 5B2, and 5C2), and the plurality of permanent magnets 8 as the magnetic member disposed at the outer tube 7 and arranged so as to face the coils 5A, 5B, and 5C with a space generated therebetween in a radial direction.

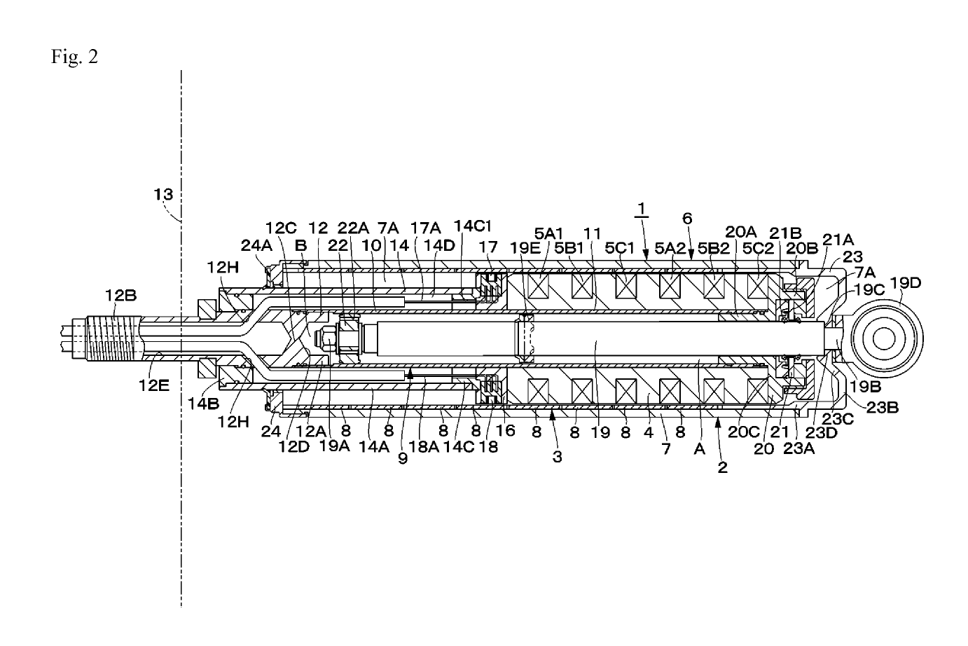

The outer tube 7 is made of, for example, a magnetic body that forms a magnetic path when being put in a magnetic field, such as a carbon steel for machine structural use (STKM12A), and the outer tube 7 is formed into a cylindrical shape. Further, the outer tube 7 extends in the axial direction, which corresponds to the stroke direction. One end side of the outer tube 7 (an end adjacent to an attachment eye 19D, i.e. the wheel side in FIGS. 1 and 2) is nonrigidly, movably, or swingably (rockingly or shakingly) coupled to a rod 19 of the cylinder apparatus 9 by a coupling member 23, which will be described below.

Hereinafter, an end closer to the attachment eye 19D will be referred to as the wheel side. Further, an end closer to a screw portion 12B attached to a vehicle body side member that is a sprung member of the vehicle will be referred to as the vehicle body side.

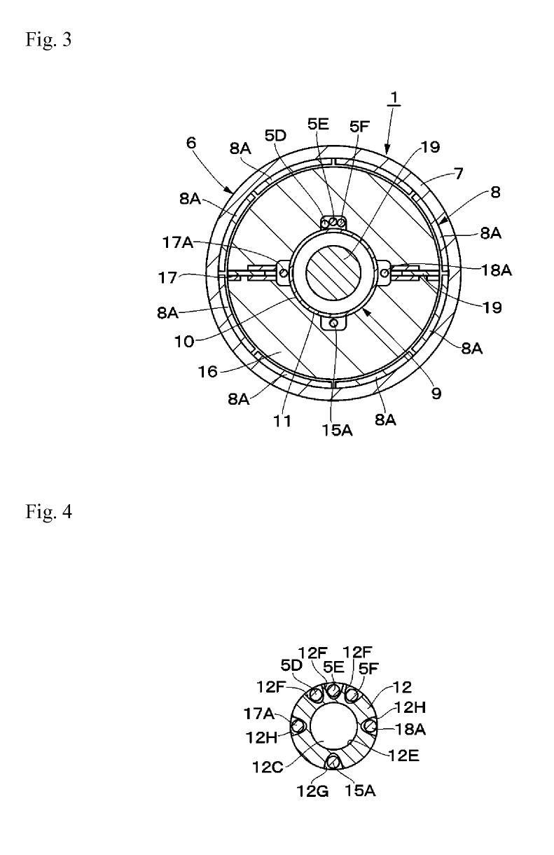

The plurality of annular permanent magnets 8 as the magnetic member, which is a member for generating a magnetic field, are arranged on an inner circumferential surface side of the outer tube 7 so as to be lined up along the axial direction. In this case, the respective permanent magnets 8 axially adjacent to each other have, for example, reverse polarities to each other. For example, supposed that the permanent magnets 8 located at odd-numbered positions if they are counted from one end side of the outer tube 7 (the wheel side or the vehicle body side) each have the N-pole on the inner circumferential surface side and the S-pole on the outer circumferential surface side. In this case, the permanent magnets 8 located at even-numbered positions if they are counted from the one end side each have the S-pole on the inner circumferential surface side and the N-pole on the outer circumferential surface side. Further, as illustrated in FIG. 3, according to the present embodiment, each of the annular permanent magnets 8 includes a plurality of arcuate magnet elements 8A. Each of the annular permanent magnets 8 is configured in such a manner that the plurality of arcuate magnet elements 8A are arranged along a circumferential direction, thereby becoming the annularly configured splittable permanent magnet 8.

When currents are supplied to the respective coils 5A1 and 5A2, 5B1 and 5B2, and 5C1 and 5C2 of the stator 2 via the power lines 5D, 5E, and 5F, an electromagnetic force is generated between the currents passing through the respective coils and the permanent magnets 8 of the movable element 6, and a thrust force (a control force or a damping force) is generated by this electromagnetic force between the stator 2 (the coils 5A1, 5B1, 5C1, 5A2, 5B2, and 5C2) and the movable element 6 (the permanent magnets 8). The not-illustrated controller connected to the respective coils 5A1 and 5A2, 5B1 and 5B2, and 5C1 and 5C2 via the power lines 5D, 5E, and 5F controls current values to be supplied to the U-phase coils 5A1 and 5A2, the V-phase coils 5B1 and 5B2, and the W-phase coils 5C1 and 5C2 in such a manner that a current magnetic flux generated by the coils 5A1, 5B1, 5C1, 5A2, 5B2, and 5C2 is offset from a magnetic flux of the permanent magnets 8 by an electrical angle of 90 degrees (i.e., corresponding to a half of the permanent magnet 8), in order to control the generated electromagnetic force to generate a thrust force as desired.

The cylinder apparatus 9 is located inside (on the radially inner side of) the stator 2 and the movable element 6, and is disposed between the vehicle body side and the wheel side. The cylinder apparatus 9 includes a cylinder 10, the rod 19, a rod guide 20, a seal member 21, and a piston 22. Then, gas (a gaseous body) such as air or nitrogen gas, and liquid such as oil or a lubricant are sealingly contained in the cylinder 10 of the cylinder apparatus 9. In the present embodiment, the cylinder apparatus 9 is configured as a cylinder apparatus that does not generate a damping force substantially except for an unavoidable resistance. Therefore, as will be described below, a communication hole 22A is formed at the piston 22, which divides the interior of the cylinder 10 into a rod-side space (a rod-side oil chamber) A and a bottom-side space (a bottom-side oil chamber) B to establish constant communication between these spaces (the oil chambers) A and B. Further, for example, a small amount of oil (lubricant) is used as the liquid in the cylinder 10. The cylinder apparatus 9 may be configured as not only a cylinder apparatus that does not generate a damping force but also a cylinder apparatus that generates a damping force.

One end side (the wheel side in FIGS. 1 and 2) of the cylinder 10 is disposed in the core 4 of the stator 2, and an opposite end side (the vehicle body side in FIGS. 1 and 2) of the cylinder 10 is attached to the vehicle body side member. The cylinder 10 includes a cylindrical tube member (a tube) 11 fittedly attached to the inner circumferential surface side of the core 4, and an attachment rod 12 fittedly fixed to an opposite end side of the tube member 11. The rod 19, which will be described below, is inserted inside the tube member 11. An outer circumferential surface of the piston 22 disposed at one end side (the vehicle body side in FIGS. 1 and 2) of the rod 19 slides on an inner circumferential surface of the tube member 11. The rod guide 20, which will be described below, is attached to one end side (the wheel side in FIGS. 1 and 2) of the tube member 11. The tube member 11, on which the piston 22 slides, has a smaller diameter (as the outer diameter and the inner diameter) than the diameter (the outer diameter and the inner diameter) of an attachment portion 20B of the rod guide 20 where the seal member 21 that will be described below is attached. Due to this configuration, it is possible to increase the diameter of the seal member 21 while reducing the width (the diameter) of the cylinder 10 (the tube member 11), thereby realizing both a reduction in the size of the cylinder apparatus 9 (thus, the whole electromagnetic suspension apparatus 1) and improvement of the sealing performance.

On the other hand, the attachment rod 12 is formed into a stepped cylindrical shape, and includes a fixation portion 12A fittedly fixed to the opposite end side of the tube member 11, and a screw portion 12B attached to the vehicle body side member that is the sprung member of the vehicle. A partitioning wall 12C is provided on an inner circumferential surface side of the attachment rod 12 to separate the one end side (the wheel side in FIGS. 1 and 2) and the opposite end side (the vehicle body side in FIGS. 1 and 2). An escape hole 12D is defined on one end side of the attachment rod 12. A distal end side of the rod 19, which will be described below, enters in the escape hole 12D when the electromagnetic suspension apparatus 1 is in a compressed state. A wiring hole 12E is defined on an opposite end side of the attachment rod 12 opposite of the partitioning wall 12C from the escape hole 12D. The power lines 5D, 5E, and 5F, and sensor lines 15A, 17A, and 18A, which will be described below, are wired in the wiring hole 12E.

A plurality of through-holes 12F, 12G, and 12H is formed on the opposite end side (the vehicle body side) of the attachment rod 12 but on the one end side (the wheel side) relative to an attachment ring 14B of a wiring container case 14, which will be described below. The through-holes 12F, 12G, and 12H extend through the attachment rod 12 between an inner circumferential surface and an outer circumferential surface of the attachment rod 12 obliquely relative to an axil central line. As illustrated in FIG. 4, as the respective through-holes 12F, 12G, and 12H, there are six holes in total, three power line through-holes 12F, a single temperature sensor line through-hole 12G, and a pair of (two) magnetic sensor line through-holes 12H. The power lines 5D, 5E, and 5F are wired (inserted) through the power line through-holes 12F. The temperature sensor line through-hole 12G is disposed radially opposite from the respective power line through-holes 12F (circumferentially shifted therefrom by approximately 180 degrees). A temperature sensor line 15A, which will be described below, is wired (inserted) through the temperature sensor line through-hole 12G. The magnetic sensor line through-holes 12H are disposed at positions shifted from the temperature sensor line through-hole 12G by approximately 90 degrees in the clockwise direction and the counterclockwise direction, respectively. The magnetic sensor lines 17A and 18B, which will be described below, are wired (inserted) through the magnetic sensor line through-holes 12H.

In other words, the power line through-holes 12F, the temperature sensor line through-hole 12G, and the pair of magnetic sensor line through-holes 12H are disposed so as to be spaced apart from their respective adjacent ones by 90 degrees in a circumferential direction of the attachment rod 12. The power lines 5D, 5E, and 5F, and the respective sensor lines 15A, 17A, and 18A are inserted from the vehicle body side through the wiring holes 12E of the attachment rod 12, are pulled out from the radially inner side toward the radially outer side of the attachment rod 12 via the respective through-holes 12F, 12G, and 12G, and axially extend toward the wheel side along the outer circumferential surface of the attachment rod 12 within the wiring container case 14.

In this case, because the armature (the core 4 and the coils 5A1, 5B1, 5C1, 5A2, 5B2, and 5C2) are disposed on the vehicle body side, it is possible to easily handle wiring of the power lines 5D, 5E, and 5F, and the respective sensor lines 15A, 17A, and 18A from the vehicle body side.

Further, the wiring hole 12E of the attachment rod 12 is opened to an interior of an engine room 13 that contains an engine (not illustrated) mounted on the vehicle body with the attachment rod 12 attached to the vehicle body side member. Therefore, the engine room 13 and an space 7A of the outer tube 7 on an radially inner side are in communication with each other via the wiring hole 12E and a wiring space 14D, which will be described below. As a result, when a change occurs in the volume of the space 7A of the outer tube 7 on the radially inner side according to a stroke (an extension/compression) of the electromagnetic suspension apparatus 1, this causes air to enter from the engine room 13 into the space 7A or exit from the space 7A into the engine room 13. Therefore, it is possible to prevent dew condensation from occurring in the space 7A of the outer tube 7 on the radially inner side, the wiring space 14D, and the like, thereby preventing deterioration of the performance, enhancing the durability, and improving the electric reliability.

The wiring container case 14 is disposed at a position axially spaced apart from the armature (the core 4 and the coils 5A1, 5B1, 5C1, 5A2, 5B2, and 5C2). The three power lines 5D, 5E, and 5F connected to the coils 5A1, 5B1, 5C1, 5A2, 5B2, and 5C2, the single temperature sensor line 15A connected to a temperature sensor 15 that detects a temperature of the core 4, and the pair of (two) magnetic sensor lines 17A and 18B connected to magnetic sensors 17 and 18, which will be described below, are contained in the wiring container case 14. The temperature sensor 15 is located on an inner circumferential side of the coils 5A, 5B, and 5C, and is disposed at (attached to) the core 4. The wiring container case 14 serves to prevent the power lines 5D, 5E, and 5F, and the sensor lines 15A, 17A, and 18A from being externally exposed even when the electromagnetic suspension apparatus 1 is in a compressed state.

The wiring container case 14 includes a tubular case main body 14A, the attachment ring 14B, and a closing ring 14C. The attachment ring 14B is fixed to one end side (the vehicle body side in FIGS. 1 and 2) of the case main body 14A, and is attached to the attachment rod 12. The closing ring 14C is fixed to an opposite end side (the wheel side in FIGS. 1 and 2) of the case main body 14A. Wiring holes 14C1, through which the power lines 5D, 5E, and 5F and the sensor lines 15A, 17A, and 18A are pulled out, are formed on the closing ring 14C so as to be circumferentially spaced apart from one another. The annular wiring space 14D is defined in the wiring container case 14. The annular wiring space 14D is defined by four surfaces (circumferential surfaces and side surfaces) in total, i.e., an inner circumferential surface of the case main body 14A, a side surface of the attachment ring 14B, a side surface of the closing ring 14C, and an outer circumferential surface of the attachment rod 12 and the tube member 11.

The power lines 5D, 5E, and 5F, and the sensor lines 15A, 17A, and 18A are arranged in the wiring space 14D so as to extend axially. In this case, the power lines 5D, 5E, and 5F, the magnetic sensor line 17A, the temperature sensor line 15A, and the magnetic sensor line 18A are disposed in the wiring container case 14 so as to be spaced apart from their respective adjacent ones by 90 degrees in the circumferential direction.

A sensor container case 16 is disposed between the wiring container case 14 and the armature (the core 4 and the coils 5A1, 5B1, 5C1, 5A2, 5B2, and 5C2) in the axial direction. The pair of magnetic sensors 17 and 18 is contained in the sensor container case 16 (refer to FIG. 2). The magnetic sensors 17 and 18 detect the magnetic flux of the permanent magnets 8 by different principles from each other. More specifically, the magnetic sensor 17 includes a magnetic resistance element that detects a magnetic field by utilizing a change in a magnetic resistance. The magnetic sensor 18 includes a Hall element (a Hall IC) that detects a magnetic pole (a polarity) by utilizing a Hall effect. This pair of magnetic sensors 17 and 18 is connected to the not-illustrated controller via the magnetic sensor lines 17A and 18B, respectively. The controller, for example, detects or calculates the axial position of the permanent magnets 8 (a stoke position or an extension/compression position) to be used for control of the electromagnetic suspension apparatus 1 based on the magnetic field, the polarity, and the like of the permanent magnets 8 detected by the pair of magnetic sensors 17 and 18. The magnetic sensors 17 and 18 may include an amplification circuit therein, if a sensor output is small.

As illustrated in FIG. 3, the pair of magnetic sensors 17 and 18 is contained in the sensor container case 16, by which the sensor container case 16 is configured as a single sensor unit. The pair of magnetic sensors 17 and 18 is disposed in the sensor container case 16 so as to be shifted from each other by 180 degrees. Further, the power lines 5D, 5E, and 5F are disposed so as to be shifted from this pair of magnetic sensors 17 and 18 by 90 degrees. Therefore, the pair of magnetic sensors 17 and 18 are located on an axial end side of the armature (the core 4 and the coils 5A1, 5B1, 5C1, 5A2, 5B2, and 5C2), whereby the pair of magnetic sensors 17 and 18 can be less likely affected by a bend, magnetization, and demagnetization of the magnetic flux that occurs by power supply to the coils 5A1, 5B1, 5C1, 5A2, 5B2, and 5C2. In addition thereto, the pair of magnetic sensors 17 and 18 is located at a same axial position, and therefore can detect a substantially same magnetic flux. Further, the power lines 5D, 5E, and 5F are shifted from the respective magnetic sensors 17 and 18 by 90 degrees, whereby the magnetic sensors 17 and 18 can be less likely affected by a noise based on the currents passing through the power lines 5D, 5E, and 5F. The magnetic sensor lines 17A and 18B connected to the magnetic sensors 17 and 18 are pulled out from same attachment angular positions as the magnetic sensors 17 and 18.

One end side (the vehicle body side in FIGS. 1 and 2) of the rod 19 is inserted in the cylinder 10, and an opposite end side (the wheel side in FIGS. 1 and 2) of the rod 19 is attached to a wheel side member. The rod 19 axially extends in the tube member 11 of the cylinder 10. The piton 22, which will be described below, is fixedly attached to the one end side of the rod 19 with use of a nut 19A or the like. On the other hand, the opposite end side of the rod 19 protrudes outwardly from the cylinder 10 via the rod guide 20, which will be described below. This protruding end side is a small-diameter portion 19B having a smaller diameter than an axial intermediate portion.

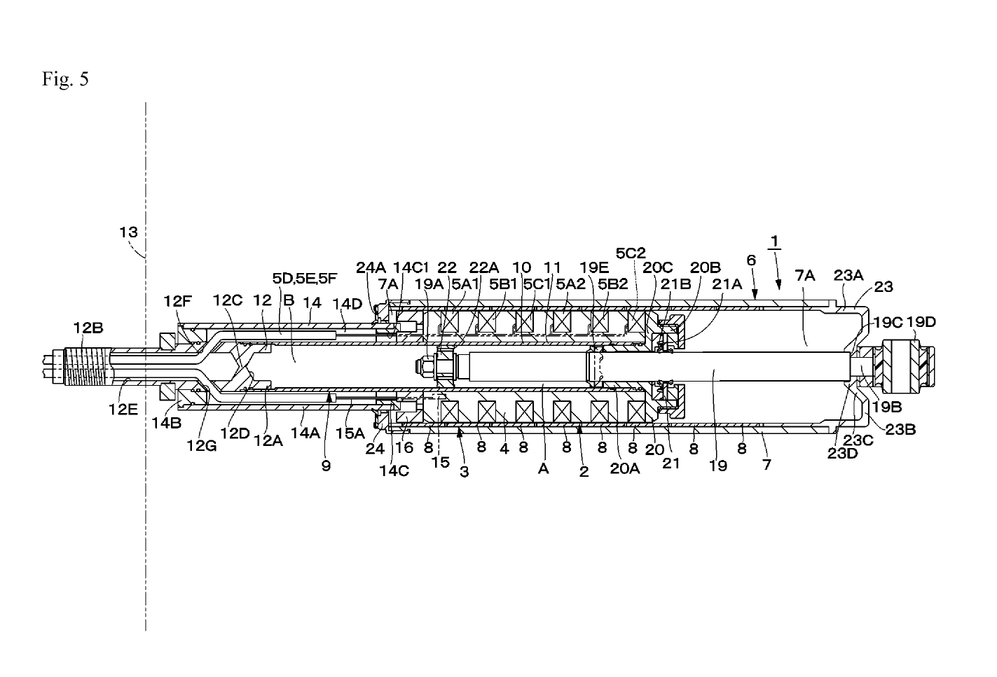

A proximal end side of the small-diameter portion 19B is continuous from the axial intermediate portion of the rod 19 via a stepped portion 19C. The coupling member 23, which will be described below, is fittedly attached (fittedly fixed) over the stepped portion 19C and the small-diameter portion 19B. Further, the attachment eye 19D, which is attached to the wheel side member that is an unsprung member of the vehicle, is fixed to a distal end side of the small-diameter portion 19B. Further, a stopper 19E made of, for example, an elastic material, is attached to the axial intermediate portion of the rod 19. As illustrated in FIG. 5, the stopper 19E serves to ease an impact generated from contact with the rod guide 20 (a guide tube portion 20A thereof), which will be described below, when the electromagnetic suspension apparatus 1 is maximally extended.

The rod guide 20 slidably supports the rod 19 on the one end side (the wheel side in FIGS. 1 and 2) of the cylinder 10. The rod guide 20 is formed into a stepped cylindrical shape as a whole. The rod guide 20 includes the guide tube portion 20A and an attachment portion 20B. An outer circumferential surface side of the guide tube portion 20A is fittedly fixed to the one end side of the cylinder 10. An inner circumferential surface side of the guide tube portion 20A slidably guides an outer circumferential surface of the rod 19. The attachment portion 20B is formed as a tube portion having a larger diameter than the guide tube portion 20A. The seal member 21, which will be described below, is attached to an inner circumferential surface side of the attachment portion 20B. The guide tube portion 20A and the attachment portion 20B are integrally connected (coupled) to each other through a flange-like connection portion 20C.

The inner diameter and the outer diameter of the attachment portion 20B are larger than the inner diameter and the outer diameter of the guide tube portion 20A. Further, the inner diameter and the outer diameter of the attachment portion 20B are larger than the inner diameter and the outer diameter of the tube member 11 of the cylinder 10. Due to this arrangement, it is possible to realize both a reduction in the size of the cylinder apparatus 9 and improvement of the sealing performance of the seal member 21.

The seal member (oil seal) 21 is disposed on the wheel side of the rod guide 20. The gas and the liquid are mixed in the cylinder 10. The thus-mixed gas and liquid are sealingly contained in the cylinder 10 by the seal member 21. Therefore, the seal member 21 is formed by a metallic plate-like annular member 21A with a hole for insertion of the rod 19 formed at the center thereof, and a rubber 21B that is a rubber member burned to an radially inner side of the annular member 21A. A rubber may be also burned to a radially outer side of the annular member 21A, if necessary.

The radially outer side of the seal member 21 is attached to the attachment portion 20B of the rod guide 20. Then, the radially inner side of the seal member 21 is in sliding contact with the outer circumferential surface of the rod 19 over the whole circumference of the seal member 21. Due to this arrangement, the seal member 21 provides a seal between the rod 19 and the cylinder 10. In this manner, the rod-side space A and the bottom-side space B in the cylinder 10 are sealingly closed by the seal member 21. This sealing prevents a foreign object such as iron powder to enter the cylinder 10, thereby reducing deterioration from wear and a damage of the rod 19, the rod guide 20, the piston 22, and the like.

The piston 22 as a guide member is disposed on the one end side (the vehicle body side in FIGS. 1 and 2) of the rod 19. The piston 22 slides in the cylinder 10. The piston 22 is fixed to the one end side of the rod 19 with use of the nut 19A and the like, and is slidably fittedly inserted in the cylinder 10. In this case, the piston 22 divides the interior of the cylinder 10 into the rod-side space A and the bottom-side space B. The communication hole 22A is formed at the piston 22 to establish communication between the rod-side space A and the bottom-side space B. The electromagnetic suspension apparatus 1 is configured in such a manner that the gas and the liquid (for example, a small amount of lubricant) in the cylinder 10 flow through the communication hole 22A of the piston 22 with almost no resistance, thereby substantially preventing a damping force from being generated between the cylinder 10 and the rod 19.

The opposite end side (the wheel side in FIGS. 1 and 2) of the rod 19 is coupled to the outer tube 7 via the coupling member 23. The coupling member 23 includes a coupling member that nonrigidly, movably, or swingably (rockingly or shakingly) couples the rod 19 and the outer tube 7. That is, according to the present embodiment, the coupling portion between the outer tube 7 and the rod 19, which is one of the coupling portion between the core 4 (the inner tube) of the armature and the cylinder 10, and the coupling portion between the outer tube 7 (the outer tube) and the rod 19, is configured to nonrigidly, movably, or swingably (rockingly or shakingly) couple the outer tube 7 and the rod 19.

The coupling member 23 as the coupling portion is formed as an elastically deformable elastic body. The coupling member 23 includes an attachment tube portion 23A, an annular portion 23B, an inclined tube portion 23C, and a fixedly attachable portion 23D. The one end side (the wheel side in FIGS. 1 and 2) of the outer tube 7 is fittedly fixed to the attachment tube portion 23A. The annular portion 23B extends from one end of the attachment tube portion 23A radially inwardly. The inclined tube portion 23C obliquely extends from a radially inner side of the annular member 23B toward the opposite end side (the vehicle body side in FIGS. 1 and 2), and has a diametrical dimension reducing toward the opposite end side. The fittedly attachable portion 23D is provided on a radially inner side of the inclined tube portion 23C and is fittedly fixed over the small-diameter portion 19B and the stepped portion 19C of the rod 19.

The fittedly attachable portion 23D is fitted to the proximal end side of the small-diameter portion 19B of the rod 19. Further, the fittedly attachable portion 23D is axially sandwiched by the stepped portion 19C and the attachment eye 19D. In this manner, the coupling member 23 is inseparably coupled to the rod 19.

As described above, the coupling member 23 is elastically deformable. Therefore, an application of a lateral force between the vehicle body and the wheel causes a radial displacement between the cylinder 10 and the rod 19 and thus misalignment between the axial central line of the cylinder 10 and the axial central line of the rod 19 according to an elastic deformation and the like of the coupling member 23. More specifically, for example, the inclined tube portion 23C is radially elastically deformed between the annular portion 23B and the fittedly attachable portion 23D. As a result, the outer tube 7 moves or swings relative to the rod 19 with the fittedly attachable portion 23D set as a center of the swing. At this time, a radial interval (a clearance) between the outer tube 7 (the permanent magnets 8) and the cylinder 10 (the armature) is limited by a bush 24, which will be described below. As a result, even when a lateral force is applied, the armature (the core 4 and the coils 5A1, 5B1, 5C1, 5A2, 5B2, and 5C2) and the permanent magnets 8 disposed at the outer tube 7 can be maintained in a state radially spaced apart from each other (a state facing each other while maintaining an interval generated therebetween).

The bush 24 is disposed between the outer tube 7 and the wiring container case 14. The bush 24 serves as a positioning member that radially positions the armature (the core 4 and the coils 5A1, 5B1, 5C1, 5A2, 5B2, and 5C2) and the permanent magnets 8. The bush 24 allows an axial relative displacement between the armature (the core 4 and the coils 5A1, 5B1, 5C1, 5A2, 5B2, and 5C2) coupled to the cylinder 10 and the permanent magnets 8 disposed at the outer tube 7 while limiting a radial relative displacement therebetween via the wiring container case 14.

An outer circumferential surface side of the bush 24 is fixed to the opposite end side of the outer tube 7. Then, the electromagnetic suspension apparatus 1 is configured in such a manner that an inner circumferential surface of the bush 24 slides on the wiring container case 14 so as to allow the wiring container case 14 to be axially relatively displaced relative to the outer tube 7, and to be slightly radially relatively displaced relative to the outer tube 7 within a range that prevents contact from being made between the coils 5A1, 5B1, 5C1, 5A2, 5B2, and 5C2 and the permanent magnets 8.

When the coupling member 23 is elastically deformed according to an application of a lateral force between the vehicle body and the wheel, the bush 24 limits a maximum elastic deformation amount of the coupling member 23 at this time so as to prevent contact (abutment) from being made between the armature (the core 4 and the coils 5A1, 5B1, 5C1, 5A2, 5B2, and 5C2) and the permanent magnets 8. Further, a seal member 24A made of an elastic member is disposed on the bush 24 to provide a seal between the outer tube 7 and the wiring container case 14. The seal member 24A serves to prevent a foreign object such iron powder from entering the space 7A of the outer tube 7 on the radially inner side.

The electromagnetic suspension apparatus 1 according to the present embodiment is configured in the above-described manner. Next, an operation thereof will be described.

For example, if the electromagnetic suspension apparatus 1 is disposed between the sprung member (the vehicle body side member) and the unsprung member (the wheel side member) of the vehicle in a vertically erected state (for example, as an inverted type in which the cylinder 10 is located on the upper side and the rod 19 is located on the lower side), a force is applied to the electromagnetic suspension apparatus 1 in the stroke direction (the axial direction) when the vehicle oscillates vertically. According to this force, the stator 2 and the movable element 6 have a relative movement therebetween together with the cylinder 10 and the rod 19. At this time, predetermined currents are supplied to the coils 5A1, 5B1, 5C1, 5A2, 5B2, and 5C2 according to magnetic pole positions of the respective permanent magnets 8, by which a damping force of the electromagnetic suspension apparatus 1 can be adjusted so that a ride comfort and steering stability of the vehicle can be improved. In the present embodiment, during a relative movement between the cylinder 10 and the rod 19, a damping force is not substantially generated between the cylinder 10 and the rod 19.

Not only a force in the stroke direction but also another force is applied to the electromagnetic suspension apparatus 1 according to a road surface condition and a running condition. For example, when the vehicle rides over a protrusion of a road surface or the vehicle turns, a force in a lateral direction (a lateral force) is applied to the electromagnetic suspension apparatus 1 besides the force in the stroke direction. When the cylinder 10 and the rod 9 are prone to be radially displaced (have misalignment between the axial central line of the cylinder 10 and the axial central line of the rod 19) according to an elastic deformation and the like due to this lateral force, the outer tube 7 moves or swings (rocks or shakes) relative to the rod 19 by the elastic deformation of the coupling member 23. As a result, even with the application of the lateral force, the armature (the core 4 and the coils 5A1, 5B1, 5C1, 5A2, 5B2, and 5C2) and the permanent magnets 8 can be maintained in a state radially spaced apart from each other so that they can be prevented from contacting each other.

In other words, according to the present embodiment, the electromagnetic suspension apparatus 1 is configured in such a manner that the cylinder 10 coupled to the core 4 of the armature and the rod 19 coupled to the outer tube 7 as the field system side are disposed inside the armature (the core 4 and the coils 5A1, 5B1, 5C1, 5A2, 5B2, and 5C2), and the cylinder 10 is attached to the vehicle body side member and the rod 19 is attached to the wheel side member. Therefore, when a lateral force is applied between the vehicle body and the wheel, this lateral force can be borne (supported) on at least two portions between the cylinder 10 and the rod 19, in particular, a sliding portion between the tube member 11 (the inner circumferential surface thereof) of the cylinder 10 and the piston 22 (the outer circumferential surface thereof), and a sliding portion between the guide tube portion 20A (the inner circumferential surface thereof) of the rod guide 20 and the rod 19 (the outer circumferential surface thereof).

In this case, the coupling portion between the outer tube 7 and the rod 19 is nonrigidly, movably, or swingably (rockingly or shakingly) coupled by the coupling member 23. Therefore, when the cylinder 10 and the rod 19 are prone to be radially displaced (have misalignment between the axial central line of the cylinder 10 and the axial central line of the rod 19) due to an application of a lateral force, the outer tube 7 moves or swings relative to the rod 19. As a result, the armature (the core 4 and the coils 5A1, 5B1, 5C1, 5A2, 5B2, and 5C2) and the permanent magnets 8 can be maintained in a state radially spaced apart from each other (a state facing each other while maintain an interval generated therebetween).

In this case, the bush 24 is disposed between the outer tube 7 and the wiring container case 14. The bush 24 limits a radial relative displacement therebetween (limits it so as to prevent them from contacting each other) while allowing an axial relative displacement therebetween. Therefore, when a lateral force is applied, the armature (the core 4 and the coils 5A1, 5B1, 5C1, 5A2, 5B2, and 5C2) and the permanent magnets 8 can be maintained in a state radially spaced apart from each other (a state facing each other while maintain an interval generated therebetween), while the applied lateral force can be released by the elastic deformation of the coupling member 23.

Therefore, for example, even with a reduction in the radial space or interval between the armature (the core 4 and the coils 5A1, 5B1, 5C1, 5A2, 5B2, and 5C2) and the permanent magnets 8, the armature (the core 4 and the coils 5A1, 5B1, 5C1, 5A2, 5B2, and 5C2) and the permanent magnets 8 can be prevented from contacting each other due to a lateral force. As a result, it is possible to reduce the size of the electromagnetic suspension apparatus 1 and secure the durability of the armature (the cores 4 and the coils 5A1, 5B1, 5C1, 5A2, 5B2, and 5C2) and the permanent magnets 8. In addition thereto, it is possible to generate a large force (a thrust force or a control force) between the armature (the core 4 and the coils 5A1, 5B1, 5C1, 5A2, 5B2, and 5C2) and the permanent magnets 8, thereby improving the performance of the electromagnetic suspension apparatus 1.

Further, because the gas and liquid are mixed in the cylinder 10, this liquid serves as a lubricant and can lubricate the sliding portion between the cylinder 10 and the rod 19. As a result, it is possible to enhance sliding performances of at least two sliding portions (the sliding portion between the cylinder 10 and the piston 22, and the sliding portion between the rod guide 20 and the rod 19). In this case, the gas and the liquid in the cylinder 10 are sealingly contained by the seal member disposed at the rod guide 20, whereby it is possible to reduce deterioration from wear and a damage due to entry of a foreign object such iron powder into the cylinder 10, thereby enhancing the durability.

Further, the amount of the liquid used in the present embodiment is small within a range that allows the rod guide 20 and the seal member 21 to be constantly immersed below the liquid surface, when the electromagnetic suspension apparatus 1 is used in a state vertically erected between the sprung member (the vehicle body side member) and the unsprung member (the wheel side member) of the vehicle, i.e., used as an inverted type in which the cylinder 10 is located on the upper side and the rod 19 is located on the lower side. This is because increasing the liquid amount to an amount that establishes a state closer to a hydraulic damper as disclosed in, for example, the above-described Japanese Patent Application Publication No. 2004-278783 will lead to generation of a damping force by the liquid, impairing the function as the electromagnetic suspension. More specifically, a large amount of liquid will cause the function of the highly responsive electromagnetic suspension to be delayed by the damping function by the liquid. Therefore, the present embodiment is characterized in that the electromagnetic suspension apparatus 1 is configured to be used as the inverted type so as to enable lubrication of the sliding portion even with the small amount of the liquid used in the present embodiment.

According to the present embodiment, the cylinder 10 is configured in such a manner that the outer diameter of the tube member 11 where the piston 22 slides is smaller than the attachment portion 20B of the rod guide 20 to which the seal member 21 is attached. As a result, it is possible to increase the diameter of the seal member 21 while reducing the width (the diameter) of the cylinder 10, thereby realizing both a reduction in the size of the cylinder apparatus 9 (thus the whole electromagnetic suspension apparatus 1) and improvement of the sealing performance.

According to the present embodiment, the electromagnetic suspension apparatus 1 is configured in such a manner that the sensor container case 16 containing the magnetic sensors 17 and 18 is disposed between the wiring container case 14 and the armature (the core 4 and the coils 5A1, 5B1, 5C1, 5A2, 5B2, and 5C2) in the axial direction.

As a result, the magnetic sensors 17 and 18 (the magnetic resistance element and the Hall IC) in the sensor container case 16 located at the axial end side of the armature (the core 4 and the coils 5A1, 5B1, 5C1, 5A2, 5B2, and 5C2) can be less likely affected by a bend, magnetization, and demagnetization of the magnetic flux generated by power supply to the coils 5A1, 5B1, 5C1, 5A2, 5B2, and 5C2, and therefore can accurately detect the magnetic flux of the permanent magnets 8. This is because the magnetic sensors 17 and 18 (the magnetic resistance element and the Hall IC) are desired to be located away from the coils 5A1, 5B1, 5C1, 5A2, 5B2, and 5C2, since the magnetic sensors 17 and 18 should not be affected by the magnetic flux generated by the coils 5A1, 5B1, 5C1, 5A2, 5B2, and 5C2 although they should acquire magnetic flux information from the permanent magnets 8 because the magnetic sensors 17 and 18 should detect the axial position (the stroke position or the extension/compression position) of the permanent magnets 8. Therefore, although a position between the coils in the axial direction can be selected as an option of the position where the magnetic sensors 17 and 18 are disposed, they are placed on the axial end of the coils for the above-described reason to reduce the influence generated by the coils (a bend, magnetization, and demagnetization of the magnetic flux) as much as possible.

That is, it is possible to detect a same magnetic flux regardless of whether power is supplied or not supplied to the coils 5A1, 5B1, 5C1, 5A2, 5B2, and 5C2 (a same magnetic flux can be detected between detection when power is supplied and detection when power is not supplied), whereby it is possible to accurately and easily detect or calculate the position of the permanent magnets 8 and thus the stroke position.

Further, the magnetic sensors 17 and 18 are disposed in the sensor container case 16 so as to be shifted from each other by 180 degrees. This shift allows the magnetic resistance element and the Hall IC to be located at a same axial position to allow them to detect a substantially same magnetic flux. Therefore, it is possible to detect or calculate the position of the permanent magnets 8 and thus the stroke position without requiring considering a difference between the axial positions where the sensors 17 and 18 are mounted, thereby facilitating positional detection or a positional calculation and improving the accuracy thereof.

Further, the power lines 5D, 5E, and 5f connected to the coils 5A1, 5B1, 5C1, 5A2, 5B2, and 5C2 are disposed in the sensor container case 16 so as to be shifted from the magnetic resistance element and the Hall IC as the magnetic sensors 17 and 18 by 90 degrees. Therefore, it is possible reduce an influence of a noise that may be generated on the magnetic sensors 17 and 18 according to the currents passing through the power lines 5D, 5E, and 5F.

More specifically, the power lines 5D, 5E, and 5F for supplying high currents are disposed at an angle shifted from the magnetic sensors 17 and 18 along the circumferential direction. Therefore, it is possible to reduce the influence of the noise on the magnetic resistance element and the Hall IC connected to the sensor signal lines, which may be generated due to the magnetic field generated around the power lines 5D, 5E, and 5F according to the high currents passing therethrough.

According to the present embodiment, the armature (the core 4 and the coils 5A1, 5B1, 5C1, 5A2, 5B2, and 5C2) is disposed on the vehicle body side, whereby it is possible to easily handle wiring from the vehicle body side to the coils 5A1, 5B1, 5C1, 5A2, 5B2, and 5C2. Further, the permanent magnets 8 are disposed on the outer circumferential side of the coils 5A1, 5B1, 5C1, 5A2, 5B2, and 5C2, whereby the magnetic flux of the permanent magnets 8 flows from the radially outer side to the radially inner side in a direction along which the cross-sectional area reduces. That is, a magnetic flux density is inversely proportional to a square of a distance, and the magnetic flux flows from the radially outer side to the radially inner side in the direction along which the cross-sectional area reduces, whereby it is possible to make a reduction in the magnetic flux density gradual. As a result, even with a change in the (radial) distance between the coils 5A1, 5B1, 5C1, 5A2, 5B2, and 5C2 and the permanent magnets 8, it is possible to reduce a change in the generated force (the thrust force or the control force). Further, even with a change in the (radial) distance between the magnetic sensors 17 and 18 and the permanent magnets 8, it is possible to reduce a change in the sensor output, thereby improving the accuracy of the positional detection or the positional calculation and facilitating it.

According to the present embodiment, the coupling portion between the rod 19 and the outer tube 7 as the nonrigidly, movably, or swingably coupled coupling portion is constituted by the coupling member 23 as the elastically deformable elastic member (including the inclined tube portion 23C). Therefore, when a lateral force is applied, the coupling member 23 is elastically deformed, by which the outer tube 7 moves or swings (rocks or shakes) relative to the rod 19 so that it is possible to stably maintain the coils 5A1, 5B1, 5C1, 5A2, 5B2, and 5C2 and the permanent magnets 8 in a state radially spaced apart from each other.

According to the present embodiment, the electromagnetic suspension apparatus 1 is configured in such a manner that the space 7A of the outer tube 7 on the radially inner side is in communication with the engine room 13. Therefore, the air enters from the engine room 13 into the space 7A or exits from the space 7A into the engine room 13, when a change occurs in the volume of the space 7A of the outer tube 7 on the radially inner side according to a relative displacement between the stator 2 and the movable element 6 (a relative displacement between the cylinder 10 and the rod 19). As a result, it is possible to prevent dew condensation from occurring in the space 7A of the outer tube 7 on the radially inner side, thereby preventing deterioration of the performance, enhancing the durability, and improving the electric reliability.

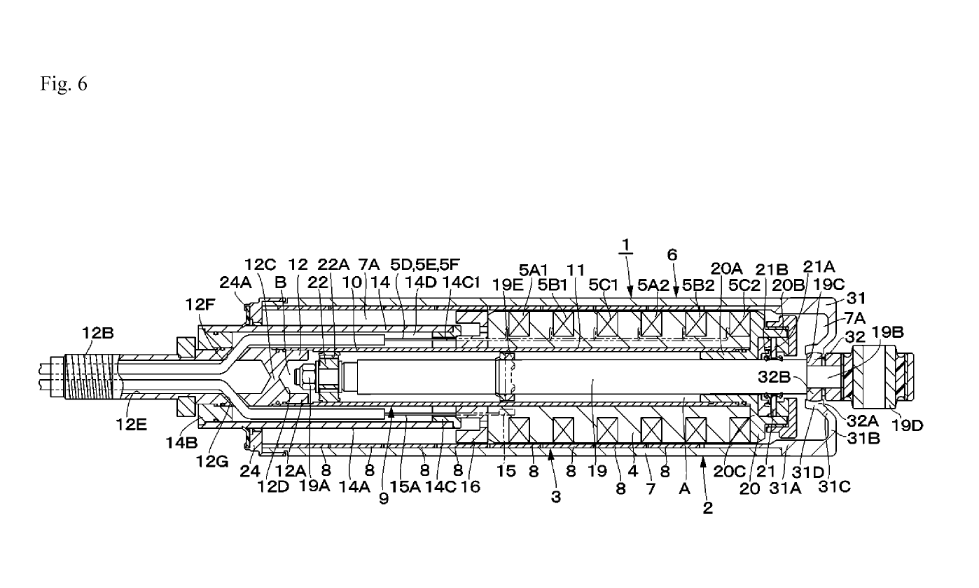

Next, FIG. 6 illustrates a second embodiment of the present invention. The present embodiment is characterized in that the coupling portion between the outer tube (the outer tube) and the rod is constituted by an elastically deformable elastic body and a spherical bearing. In the present embodiment, similar components to the above-describe first embodiment are denoted by the same reference numerals to the first embodiment, and descriptions thereof will be omitted herein.

The opposite end side (the wheel side in FIG. 6) of the rod 19 is coupled to the outer tube 7 via a coupling member 31 and a spherical bearing 32. The coupling member 31 and the spherical bearing 32 constitute the coupling portion that nonrigidly, movably, or swingably (rockingly or shakingly) couples the rod 19 and the outer tube 7.

The coupling member 31 is formed as an elastically deformable elastic member, and includes an attachment tube portion 31A, an annular portion 31B, an inclined tube portion 31C, and a fittedly attachable portion 31D. The one end side (the wheel side in FIGS. 1 and 2) of the outer tube 7 is fittedly fixed to the attachment tube portion 31A. The annular portion 31B extends from one end side of the attachment tube portion 31A to the radially inner side. The inclined tube portion 31C obliquely extends from a radially inner side of the annular member 31B to the opposite end side (the vehicle body side in FIGS. 1 and 2), and has a diametrical dimension reducing toward the opposite end side. The fittedly attachable portion 31D is provided on a radially inner side of the inclined tube portion 31C and also serves as an outer ring (housing) 32A of the spherical bearing 32.

The spherical bearing 32 includes the outer ring (housing) 32A and an inner ring 32B. The outer ring (housing) 32A is formed integrally with the coupling member 31, and has a spherically concaved surface on an inner circumferential surface side thereof. The inner ring 32B has a spherically convexed surface on an outer circumferential surface side thereof, and is nonrigidly, movably, or swingably (rockingly or shakingly) fitted to the outer ring 32A. Further, a radially inner side of the inner ring 32B is fittedly fixed to the small-diameter portion 19B of the rod 19. The inner ring 32B of the spherical bearing 32 is fitted to the proximal end side of the small-diameter portion 19B of the rod 19 and is also axially sandwiched by the stepped portion 19C and the attachment eye 19D, by which the coupling member 31 and the spherical bearing 32 are inseparably coupled to the rod 19.

When the cylinder 10 and the rod 19 are prone to be radially displaced (have misalignment between the axial central line of the cylinder 10 and the axial central line of the rod 19) according to an elastic deformation and the like due to an application of a lateral force between the vehicle body and the wheel, the coupling member 31 moves or swings (rocks or shakes) with the inner ring 32B of the spherical bearing 32 set as a center of the swing (the inclined tube portion 31C is elastically deformed, if necessary). As a result, the outer tube 7 moves or swings (rocks or shakes) relative to the rod 19, whereby it is possible to maintain the coils and 5A1, 5B1, 5C1, 5A2, 5B2, and 5C2 and the permanent magnets 8 in a state radially spaced apart from each other (a state facing each other while maintaining an interval generated therebetween) even when a lateral force is applied.

In this manner, the thus-configured second exemplary embodiment can also obtain a substantially similar effect to the above-described first embodiment. Especially, according to the second embodiment, the coupling portion between the rod 19 and the outer tube 7 includes the coupling member 31 as the elastically deformable elastic body, and the spherical bearing 32 in which the outer ring 32 moves or swings relative to the inner ring 32B. Therefore, when a lateral force is applied, it is possible to further stably maintain the coils and 5A1, 5B1, 5C1, 5A2, 5B2, and 5C2 and the permanent magnets 8 in a state radially spaced apart from each other due to a move or swing of the spherical bearing 32 (an elastic deformation of the coupling member 31, if necessary). Further, the employment of the spherical bearing 32 causes the outer ring 32A of the spherical bearing 32 to moves or swing to be displaced relative to the inner ring 32B, thereby preventing a reaction force generated according to an elastic deformation, like an elastic deformation of the coupling member 31, from being applied to the outer tube 7. As a result, it is possible to reduce a force applied to the bush 24, thereby enhancing the durability of the bush 24. The coupling member 31 may be also configured as a member that cannot be elastically deformed.

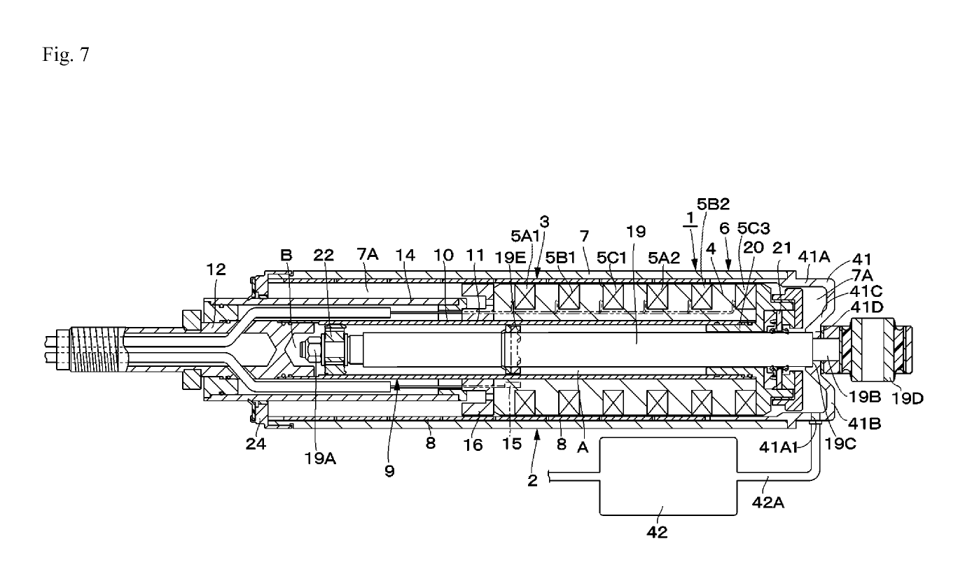

Next, FIG. 7 illustrates a third embodiment of the present invention. The present embodiment is characterized in that the electromagnetic suspension apparatus is configured in such a manner that the space of the outer tube on the radially inner side is connected (communicated) to a drier. In the present embodiment, similar components to the above-describe first embodiment are denoted by the same reference numerals to the first embodiment, and descriptions thereof will be omitted herein.

A coupling member 41 that nonrigidly, movably, or swingably (rockingly or shakingly) couples the outer tube 7 and the rod 19 includes an attachment tube portion 41A, an annular portion 41B, an inclined tube portion 41C, and a fittedly attachable portion 41D, in a similar manner to the coupling member 23 in the above-described first embodiment. Then, the attachment tube portion 41A has a through-hole 41A1 extending between an inner circumferential surface and an outer circumferential surface. Then, a ventilation tube 42A, which leads to a drier 42, is connected to the through-hole 41A1, by which the space 7A of the outer tube 7 on the radially inner side is connected (communicated) to the drier 42. The drier 42 serves to dry gas that enters in or exits from the space 7A of the outer tube 7 on the radially inner side.

In this manner, the thus-configured third embodiment can also obtain a substantially similar effect to the above-described first embodiment. Especially, according to the third embodiment, when a change occurs in the volume of the space 7A of the outer tube 7 on the radially inner side according to a stroke (an extension/compression) of the electromagnetic suspension apparatus 1, air dried by the drier 42 enters in or exits from the space 7A. As a result, it is possible to prevent dew concentration from occurring in the space 7A of the outer tube 7 on the radially inner side, thereby preventing deterioration of the performance, enhancing the durability, and improving the electric reliability.

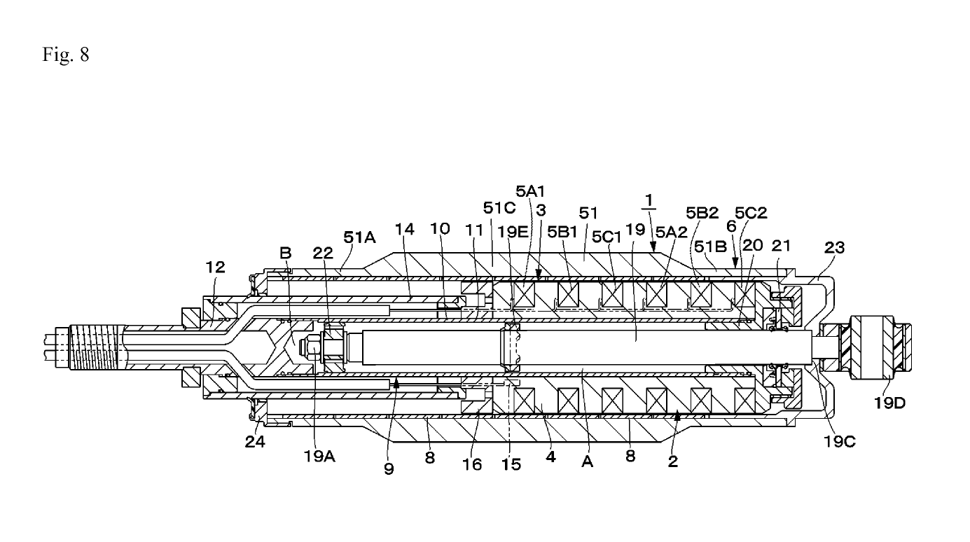

Next, FIG. 8 illustrates a fourth embodiment of the present invention. The present embodiment is characterized in that a wall of the outer tube, where the magnetic member is mounted, is thinner at both the axial ends of the outer tube than at the axial intermediate portion (the wall of the intermediate portion is thicker than those of the both ends). In the present embodiment, similar components to the above-describe first embodiment are denoted by the same reference numerals to the first embodiment, and descriptions thereof will be omitted herein.

An outer tube 51, which serves as the outer tube, is formed into a cylindrical shape. The outer tube 51 extends in the axial direction, which corresponds to the stroke direction. A wall of the outer tube 51 is thinner at one axial end 51A and an opposite axial end 51B than at an axial intermediate portion 51C. Conversely, the wall at the intermediate portion 51C of the outer tube 51 is thicker than the walls at the both ends 51A and 51B.

The thus-configured fourth embodiment can also obtain a substantially similar effect to the above-described first embodiment. Especially, according to the fourth embodiment, the outer tube 51 can have a thick wall at the axial intermediate portion 51C of the outer tube 51 where the permanent magnets 8 are mounted. As a result, it is possible to prevent magnetic saturation to thereby obtain a large generated force at the axial intermediate portion 51C (around a stroke center) where a large control force is required during running stability control and the like. On the other hand, the outer tube 51 can have a thinner wall at the one axial end 51A and the opposite axial end 51B where a large control force is not required, whereby it is possible to reduce the weight while enabling generation of a control force required for all strokes. Further, it is possible to reduce the sizes (diameters) of the one end 51A and the opposite end 51B of the outer tube 51 that are respectively located close to the attachment portions to the vehicle body side member and the wheel side member, whereby it is also possible to reduce interference with the vehicle body side member and the wheel side member.

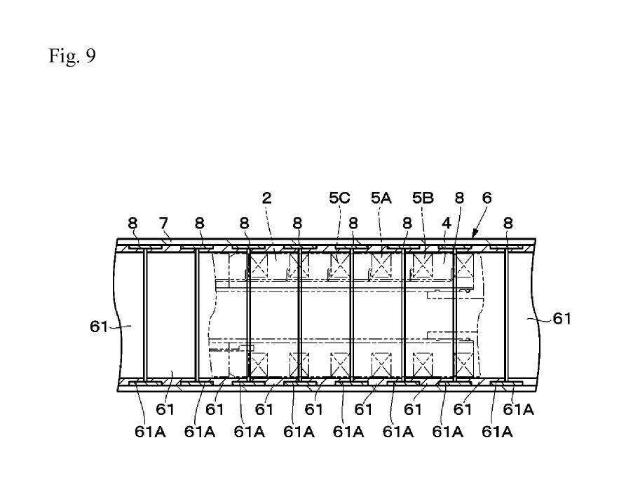

Next, FIG. 9 illustrates a fifth embodiment of the present invention. The present embodiment is characterized in that the electromagnetic suspension apparatus is configured in such a manner that a magnetic body is disposed between the magnetic member and the coil member. In the present embodiment, similar components to the above-describe first embodiment are denoted by the same reference numerals to the first embodiment, and descriptions thereof will be omitted herein.

Annular members 61 as the magnetic body are disposed on the inner circumferential surface side of the permanent magnets 8 between the permanent magnets 8 and the coils 5A1, 5B1, 5C1, 5A2, 5B2, and 5C2. Each of the annular members 61 is made of a magnetic body (a magnetic member) that generates a magnetic path when being put in a magnetic field, such as a carbon steel for machine structural use (STKM12A), and is formed into a cylindrical shape. Each of the annular members 61 has a small-diameter portion 61A, which is fitted to the end of the permanent magnet 8, on an outer circumferential surface side thereof. Each of the annular members 61 is arranged so as to bridge between the axially adjacent permanent magnets 8 on the radially inner side of the outer tube 7.

The thus-configured fifth embodiment can also obtain a substantially similar effect to the above-described first embodiment. Especially, according to the fifth embodiment, the annular members 61 made of magnetic bodies are disposed between the permanent magnets 8 and the coils 5A1, 5B1, 5C1, 5A2, 5B2, and 5C2. Therefore, it is possible to reduce the magnetic resistance of a magnetic path, whereby it is possible to generate a large force (a thrust force or a control force) while reducing the sizes of the expensive permanent magnets 8. Further, it is also possible to protect the permanent magnets 8 by the annular members 61.

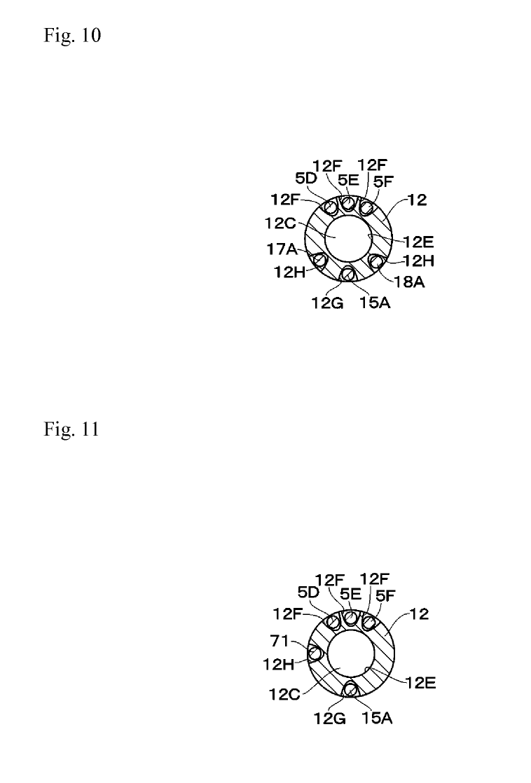

The above-described first embodiment has been described based on the example in which the electromagnetic suspension apparatus 1 is configured in such a manner that the power line through-holes 12F, the temperature sensor line through-hole 12G, and the pair of magnetic sensor line though-holes 12H are formed at the attachment rod 12 so as to be spaced apart from their respective adjacent ones by 90 degrees (arranged at even intervals in the circumferential direction). However, the present invention is not limited thereto. For example, like a first modification illustrated in FIG. 10, the electromagnetic suspension apparatus 1 may be configured in such a manner that the pair of magnetic sensor line through-holes 12H are disposed closer to the temperature sensor line through-hole 12G (farther away from the power line through-holes 12F). The holes may be arranged at uneven intervals in the circumferential direction. In this case, it is possible to increase the intervals between the power lines 5D, 5E, and 5F and the sensor lines 15A, 17A, and 18A, thereby reducing an influence of a noise on the sensor lines 15A, 17A, and 18 by the power lines 5D, 5E, and 5F though which high currents flow.

The above-described first embodiment has been described based on the example in which the electromagnetic suspension apparatus 1 is configured in such a manner that the magnetic sensor lines 17A and 18A are pulled out from the pair of magnetic sensors 17 and 18, respectively. However, the present invention is not limited thereto. For example, like a second modification illustrated in FIG. 11, the electromagnetic suspension apparatus 1 may be configured in such a manner that a common magnetic line sensor line 71 (for example, using a common power source and a GND line) is pulled out from the pair of magnetic sensors 17 and 18. In this case, only a single through-hole is required as the magnetic sensor line through-hole 12H. Further, it is possible to improve handling of wiring, reduce risks of breaking and short-circuiting of the wire, and the like due to the reduction in the number of wires.

The above-described first embodiment has been described based on the example in which the electromagnetic suspension apparatus 1 is configured in such a manner that the space 7A of the outer tube 7 (the outer tube) on the radially inner side is in communication with the engine room 13. However, the present invention is not limited thereto. For example, the electromagnetic suspension apparatus 1 may be configured in such a manner that the space of the outer tube on the radially inner side is in communication with an interior of a vehicle compartment where a passenger is seated. In this case, it is also possible to prevent dew condensation from occurring in the space 7 of the outer tube on the radially inner side, thereby preventing deterioration of the performance, enhancing the durability, and improving the electric reliability.

The above-described second embodiment has been described based on the example in which the electromagnetic suspension apparatus 1 is configured in such a manner that the outer tube 7 and the rod 19 are coupled to each other via both the coupling member 31 and the spherical bearing 32. However, the present invention is not limited thereto. For example, the movable or swingable coupling portion may be constituted by only the spherical bearing. Further, the movable or swingable coupling portion may be realized by various kinds of coupling configurations as long as it can nonrigidly, movably, or swingably couple a pair of members that are coupling targets. For example, the movable or swingable coupling portion may be realized by reducing a thickness of a part of the coupling member to configure this portion as an elastically deformable portion, besides configuring the coupling portion as an elastically deformable elastic body by using the coupling member having the inclined tube portion, or using the spherical bearing for the coupling portion.

The above-described fourth embodiment has been described based on the example in which the wall of the outer tube 51 is thinner at the both axial ends 51A and 51B than at the axial intermediate portion 51C. However, the present invention is not limited thereto. For example, the wall of at least one of the one axial end and the opposite axial end of the outer tube or the inner tube where the magnetic member is mounted may be thinner than the wall at the intermediate portion.

The above-described respective embodiments have been described based on the example in which the electromagnetic suspension apparatus 1 is configured to nonrigidly, movably, or swingably (rockingly or shakingly) couple the coupling portion between the outer tube 7 and the rod 19, which is one of the coupling portion between the core 4 (the inner tube) of the armature and the cylinder 10, and the coupling portion between the outer tube 7 (the outer tube) on the field system side and the rod 19. However, the present invention is not limited thereto. For example, the electromagnetic suspension apparatus 1 may be configured to nonrigidly, movably, or swingably (rockingly or shakingly) couple the coupling portion between the inner tube and the cylinder, which is one of the coupling portion between the inner tube and the cylinder, and the coupling portion between the outer tube and the rod. Alternatively, the electromagnetic suspension apparatus 1 may be configured to nonrigidly, movably, or swingably (rockingly or shakingly) couple both the coupling portion between the inner tube and the cylinder, and the coupling portion between the outer tube and the rod. Further, the electromagnetic suspension apparatus 1 may be configured in such a manner that the inner tube and the rod are nonrigidly, movably, or swingably (rockingly or shakingly) coupled to each other, and the outer tube and the cylinder are nonrigidly, movably, or swingably (rockingly or shakingly) coupled to each other.

The above-described respective embodiments have been described based on the example in which the tubular linear electromagnetic actuator is constituted by the coils 5A1, 5B1, 5C1, 5A2, 5B2, and 5C2 (the coil member) disposed at the core 4 corresponding to the inner tube, and the permanent magnets (the magnetic member) disposed at the outer tube 7 corresponding to the outer tube. However, the present invention is not limited thereto. For example, the tubular linear electromagnetic actuator may be constituted by coils (the coil member) disposed at the outer tube, and permanent magnets (the magnetic member) disposed at the inner tube.

The above-described respective embodiments have been described based on the example in which the electromagnetic suspension apparatus 1 is configured in such a manner that the stator 2 is attached to the sprung member (for example, the vehicle body side member) of the vehicle, and the movable element 6 is attached to the unsprung member (for example, the wheel side member) of the vehicle. However, the present invention is not limited thereto. For example, the electromagnetic suspension apparatus 1 may be configured in such a manner that the stator is attached to the unsprung member of the vehicle, and the movable element is attached to the sprung member.

The above-described respective embodiments have been described based on the example in which the electromagnetic suspension apparatus 1 is configured to be attached to the vehicle such as an automobile in a vertically erected state. However, the present invention is not limited thereto. For example, the electromagnetic suspension apparatus 1 may be configured to be attached to a vehicle such as a railroad vehicle in a horizontally laid state.

The above-described respective embodiments have been described based on the example in which the electromagnetic suspension apparatus 1 is configured to be installed on the vehicle. However, the present invention is not limited thereto. For example, the electromagnetic suspension apparatus 1 may be used as an electromagnetic suspension apparatus for use in various types of machines, buildings, and the like that become a vibration source.

Further, the above-described respective embodiments have been described based on the example in which the electromagnetic suspension apparatus 1 is constituted by the linear motor circular in transverse cross-section, i.e., the stator 2 and the movable element 6 are formed into cylindrical shapes. However, the present invention is not limited thereto. For example, the electromagnetic suspension apparatus 1 may be constituted by a tubular linear motor having another shape than a circular shape in transverse cross-section, such as a liner motor having an I shape (a flat plate shape), a rectangular shape, and an H shape in transverse cross-section.

According to the above-described embodiments, it is possible to reduce the size, improve the performance, and enhance the durability of the electromagnetic suspension apparatus.

According to one embodiment of the present invention, the electromagnetic suspension apparatus is configured in such a manner that the cylinder coupled to one of the inner tube and the outer tube, and the rod coupled to the other are disposed within the inner tube, and the cylinder and the rod are attached to the vehicle body side member and the wheel side member, respectively. Therefore, when a lateral force is applied between the vehicle body and the wheel, this lateral force can be borne (supported) on at least two portions between the cylinder and the rod, in particular, the sliding portion between the cylinder (the inner circumferential surface thereof) and the piston (the outer circumferential surface thereof), and the sliding portion between the rod guide (the inner circumferential surface thereof) and the rod (the outer circumferential surface thereof).

In this case, the coupling portion between one of the inner tube and the outer tube and the cylinder, and/or the coupling portion between the other and the rod are/is nonrigidly, movably, or swingably coupled. Therefore, when the cylinder and the rod are prone to be radially displaced (have misalignment between the axial central line of the cylinder and the axial central line of the rod) according to an elastic deformation or the like due to an application of a lateral force, the outer tube and/or the inner tube move(s) or swing(s) relative to the cylinder or the rod at the movable or swingable coupling portion. As a result, it is possible to maintain the coil member disposed at one of the inner tube and the outer tube and the magnetic member disposed at the other in a state radially spaced apart from each other (a state facing each other while maintaining the interval generated therebetween).

In this case, the movable or swingable coupling portion, for example, limits (sets) the positional relationship between the coil member and the magnetic member so as to prevent them from contacting (abutting) each other when the outer tube and/or the inner tube maximally move(s) or swing(s), and/or the positioning member such the bush is disposed between the inner tube and the outer tube (between the coil member and the magnetic member) so as to limit a radial relative displacement therebetween (limit it so as to prevent them from contacting each other) while allowing an axial relative displacement therebetween. As a result, when a lateral force is applied, it is possible to maintain the inner tube and the outer tube (the coil member and the magnetic member) in a state radially spaced apart from each other (a state facing each other with the interval maintained therebetween) while releasing this lateral force at the movable or swingable coupling portion.

Therefore, for example, even with a reduction in the radial interval between the coil member and the magnetic member, the coil member and the magnetic member can be prevented from contacting each other due to an application of a lateral force. As a result, it is possible to reduce the size of the electromagnetic suspension apparatus and secure the durability of the coil member and the magnetic member. In addition thereto, it is possible to generate a large force (a thrust force or a control force) between the coil member and the magnetic member, thereby improving the performance of the electromagnetic suspension apparatus.

Further, because the gas and liquid are mixed in the cylinder, this liquid serves as a lubricant and can lubricate the sliding portion between the cylinder and the rod. As a result, it is possible to enhance sliding performances of at least two sliding portions (the sliding portion between the cylinder and the piston, and the sliding portion between the rod guide and the rod). In this case, the gas and the liquid in the cylinder are sealingly contained by the seal member disposed at the rod guide, whereby it is possible to reduce deterioration from wear and a damage due to entry of a foreign object such iron powder into the cylinder, thereby enhancing the durability.

According to one embodiment of the present invention, the cylinder is configured to have a smaller outer diameter at the portion where the guide member slides than the attachment portion of the rod guide where the seal member is attached. As a result, it is possible to increase the diameter of the seal member while reducing the width (diameter) of the cylinder, thereby realizing both a reduction in the size as the whole apparatus and improvement of the sealing performance.

According to one embodiment of the present invention, the electromagnetic suspension apparatus is configured in such a manner that the magnetic sensors for detecting the position of the magnetic member, i.e., the magnetic resistance element and the Hall IC are contained in the sensor container case, and the sensor container case is disposed between the wiring container case and the coil member in the axial direction. As a result, the magnetic resistance element and the Hall IC in the sensor container case located on the axial end side of the coil member can be less likely affected by a bend, magnetization, and demagnetization of the magnetic flux generated by power supply to the coil member, and therefore can accurately detect the magnetic flux of the magnetic member. That is, it is possible to detect a same magnetic flux regardless of whether power is supplied or not supplied to the coil member (a same magnetic flux is detected between detection when power is supplied and detection when power is not supplied), whereby it is possible to accurately and easily detect or calculate the position of the magnetic member and thus the stroke position.

In addition, the magnetic resistance element and the Hall IC are disposed in the sensor container case 16 so as to be shifted from each other by 180 degrees. This shift allows the magnetic resistance element and the Hall IC to be located at a same axial position to allow them to detect a substantially same magnetic flux. Therefore, it is possible to detect or calculate the position of the magnetic member and thus the stroke position without requiring considering a difference between the axial positions where the sensors are mounted, thereby facilitating the positional detection or the positional calculation and improving the accuracy thereof.

Further, the power line connected to the coil member is disposed in the sensor container case so as to be shifted from the magnetic resistance element and the Hall IC, which are the magnetic sensors, by 90 degrees. Therefore, it is possible to reduce an influence of a noise generated on the magnetic sensors according to the current passing through the power line.

According to one embodiment of the present invention, the inner tube where the coil member is mounted is located on the vehicle body side, whereby it is possible to easily handle wiring to the coil member from the vehicle body side. Further, the magnetic member is disposed on the outer circumferential side of the coil member, whereby the magnetic flux of the magnetic member flows from the radially outer side to the radially inner side in the direction along which the cross-sectional area reduces. That is, a magnetic flux density is inversely proportional to a square of a distance, and the magnetic flux flows from the radially outer side to the radially inner side in the direction along which the cross-sectional area reduces, whereby it is possible to make a reduction in the magnetic flux density gradual. As a result, even with a change in the radial distance between the coil member and the magnetic member, it is possible to reduce a change in the generated force (the thrust force or the control force). Further, in a case that the magnetic sensors are disposed on the inner circumferential side of the magnetic member, even with a change in the radial distance between the magnetic sensors and the magnetic member, it is possible to reduce a change in the sensor output, thereby improving the accuracy of the positional detection or the positional calculation and facilitating it.

According to one embodiment of the present invention, the nonrigidly, movably, or swingably coupled coupling portion is constituted by the elastically deformable elastic body and/or the spherical bearing. Therefore, when a lateral force is applied, the coupling portion is elastically deformed and/or the spherical bearing is displaced along the spherical surface, by which the outer tube and/or inner tube move(s) or swing(s) relative to the cylinder or the rod. As a result, even when a lateral force is applied, it is possible to stably maintain the inner tube and the outer tube (the coil member and the magnetic member) in a state radially spaced apart from each other.

According to one embodiment of the present invention, the electromagnetic suspension apparatus is configured in such a manner that the space of the outer tube on the radially inner side is in communication with the interior of the engine room or the vehicle compartment. Therefore, when a change occurs in the volume of the space of the outer tube on the radially inner side according to a relative displacement between the outer tube and the inner tube, the air enters from the engine room or the vehicle compartment into the space of the outer tube on the radially inner side or exits from the space of the outer tube on the radially inner side into the engine room or the vehicle compartment. As a result, it is possible to prevent dew condensation from occurring in the space of the outer tube on the radially inner side, thereby preventing deterioration of the performance, enhancing the durability, and improving the electric reliability.

According to one embodiment of the present invention, the electromagnetic suspension apparatus is configured in such a manner that the space of the outer tube on the radially inner side is connected to the drier. Therefore, when a change occurs in the volume of the space of the outer tube on the radially inner side according to a relative displacement between the outer tube and the inner tube, the air dried by the drier enters in or exits from the space of the outer tube on the radially inner side. As a result, it is possible to prevent dew condensation from occurring in the space of the outer tube on the radially inner side, thereby preventing deterioration of the performance, enhancing the durability, and improving the electric reliability.

According to one embodiment of the present invention, the outer tube or the inner tube can have a thick wall at the axial intermediate portion of the outer tube or the inner tube where the magnetic member is mounted. As a result, it is possible to prevent magnetic saturation to thereby obtain a large generated force at the axial intermediate portion (around the stroke center) where a large control force is required during the running stability control and the like. On the other hand, the outer tube or the inner tube can have a thinner wall at the one axial end and/or the opposite axial end where a large control force is not required, whereby it is possible to reduce the weight while enabling generation of a control force required for all strokes. Further, it is possible to reduce the size (diameter) of the axial end of the outer tube or the inner tube that is located close to the attachment portion to the vehicle body side member or the wheel side member, whereby it is also possible to reduce interference with the vehicle body side member and/or the wheel side member.

According to one embodiment of the present invention, the electromagnetic suspension apparatus is configured in such a manner that the magnetic body is disposed between the magnetic member and the coil member. Therefore, it is possible to reduce the magnetic resistance of the magnetic path, whereby it is possible to generate a large force (a thrust force or a control force) while reducing the size of the expensive magnetic member. Further, it is also possible to protect the magnetic member by the magnetic body.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2013-038982 filed on Feb. 28, 2013.

The entire disclosure of Japanese Patent Application No. 2013-038982 filed on Feb. 28, 2013 including specification, claims, drawings and summary are incorporated herein by reference in its entirety.

What is claimed is:

1. An electromagnetic suspension apparatus configured to be disposed between a vehicle body and a wheel, comprising:
a tubular linear electromagnetic actuator including a coil member disposed at one of relatively displaceable coaxial inner and outer tubes, and a magnetic member disposed at the other of the inner and outer tubes and arranged so as to face the coil member;
a cylinder including one end side disposed in the inner tube, and an opposite end side configured to be attached to a vehicle body side member;
a rod including one end side inserted in the cylinder, and an opposite end side configured to be attached to a wheel side member;
a rod guide arranged to slidably support the rod on the one end side of the cylinder;
a seal member disposed on a wheel side of the rod guide, and arranged to provide a seal to gas and liquid mixed in the cylinder; and
a guide member disposed on the one end side of the rod, and configured to slide in the cylinder,
wherein one of the inner tube and the outer tube is coupled to the cylinder,
the other of the inner tube and the outer tube is coupled to the rod, and
the electric magnetic suspension apparatus includes one of a first state and a second state,
in the first state, coupling portion between the cylinder and the one of the inner tube and the outer tube is nonrigidly coupled,
in the second state, a coupling portion between the rod and the other of the inner tube and the outer tube is nonrigidly coupled.

2. The electromagnetic suspension apparatus according to claim 1, wherein the seal member is formed by burning a rubber onto a radially inner side of a plate-like annular member,
the rod guide includes an attachment portion to which the seal member is attached, and
the cylinder has a smaller outer diameter at a portion where the guide member slides than the attachment portion of the rod guide.

3. The electromagnetic suspension apparatus according to claim 1, wherein a wiring container case containing a power line connected to the coil member is disposed at a position axially spaced apart from the coil member, and
a sensor container case is disposed between the wiring container case and the coil member in an axial direction, and the sensor container case contains a magnetic resistance element and a Hall IC disposed so as to be shifted from each other by 180 degrees, and the power line disposed so as to be shifted from the magnetic resistance element and the Hall IC by 90 degrees.

4. The electromagnetic suspension apparatus according to claim 1, wherein the coil member is disposed at the inner tube,
the magnetic member is disposed at the outer tube on a circumferentially outer side of the coil member, and
the inner tube is disposed on a vehicle body side, and the outer tube is disposed on a wheel side.

5. The electromagnetic suspension apparatus according to claim 1, wherein the nonrigidly coupled coupling portion to the rod includes an elastically deformable elastic body and/or a spherical bearing.

6. The electromagnetic suspension apparatus according to claim 1, wherein a space of the outer tube on a radially inner side is in communication with at least one of an engine room that contains an engine installed on the vehicle body and a vehicle compartment where a passenger of the vehicle is seated.

7. The electromagnetic suspension apparatus according to claim 1, wherein a space of the outer tube on a radially inner side is connected to a drier configured to dry gas that enters in and/or exits from the space.

8. The electromagnetic suspension apparatus according to claim 1, wherein a wall of the outer tube or the inner tube where the magnetic member is disposed is thinner at one axial end and/or an opposite axial end than at an axial intermediate portion.

9. The electromagnetic suspension apparatus according to claim 1, wherein a magnetic body is disposed between the magnetic body and the coil member.
